(19) United States
(12) Patent Application Publication
(10) Pub. No.: US 2015/0027018 A1
(43) Pub. Date: Jan. 29, 2015

(54) PROTECTIVE CERTIFICATE PACKAGE SYSTEM AND METHOD OF MANUFACTURE THEREOF

(71) Applicant: Jean Pierre Cayer, Woodbridge (CA)

(72) Inventor: Jean Pierre Cayer, Woodbridge (CA)

(21) Appl. No.: 13/948,607

(22) Filed: Jul. 23, 2013

(51) Int. Cl. G09F 1/12; B65B 25/14

(52) U.S. Cl. CPC G09F 1/12; B65B 25/14
USPC 40/771; 53/428

(57) ABSTRACT

A protective certificate cover system and method of manufacture thereof is provided having a certificate or diploma, a protective cover having two panels, a cover aperture formed in one panel configured to be aligned with a printed name area on the certificate when the certificate is closed within the cover. An envelope has a viewing window so the printed name area is visible when the closed cover containing the certificate is inserted into the envelope. A transparent sleeve is provided permitting the envelope containing the cover to be shrink wrapped and sealed.

### BACKGROUND OF THE INVENTION

1. Technical Field

The present invention relates generally to a system for protecting a certificate or diploma and method of producing thereof. More particularly, a protective system for a certificate includes a cost reducing protective package having a visible printed name area when assembled and protected. Specifically, the system of the present invention has a certificate on which a name is printed in the name area visible through an aperture formed in a first panel of a protective cover configured to close about a living hinge and slide into an envelope and transparent sleeve.

2. Background Information

A physical memorialization of educational achievements, such as diploma or certificate, is given to a qualified person who has met certain minimum requirements, such as a course load at a university. These certificates are often personalized for each individual having the recipient's name printed on the certificate. The certificates are sometimes closed within a protective cover embossed with the granting institution's emblem. The protective cover containing the certificate is then separately labeled on the outside of the cover with the recipient's name creating a certificate package. Then, the certificate packages containing the diplomas are handed out to many qualifying individuals at one time, usually at a graduation ceremony. Large graduation ceremonies can easily exceed one hundred people.

For the graduation ceremony coordinator, a problem often arises in assembling the certificate packages. Assembly requires ensuring the printed name on the certificate matches the label on the outside of the cover. This is very time consuming and can still lead to errors which result in individuals receiving the incorrect certificate. Further, it can be difficult to arrange the certificates in the correct alphabetical order without seeing the certificates closed within the cover. Further, not all diploma or certificate recipients actually show up to graduation, thus a problem arises when the recipients walk across the ceremony stage in an order not congruous with the stack of certificates to be awarded.

The present invention addresses these and other issues.

### SUMMARY

The present invention may provide an award certificate having preprinted names and award status on the certificate protected in a certificate cover having an aperture aligned with the printed name and wrapped in a protective envelope or transparent sleeve. The present invention may further provide a method for a ceremony coordinator to input names or information for each certificate recipient, then the information is transmitted to a certificate system having programmed software to arrange the certificates in a desired order via computer logic, the arranged certificates are then printed. The certificates are then placed or manually installed into the protective cover with the aperture facing upward. This is advantageous over previous methods and devices as the certificate system provides a cost savings for the granting institution in that there is no need to print the recipient's name on a label on the cover and then spend man-hours ensuring the certificates match the label on the cover.

In one aspect, the invention may provide a method of producing a protective certificate package, the method comprising the steps of: providing an electronic certificate system programmed to receive at least one certificate recipient's name via an entry form; inputting at least one certificate recipient name via the entry form into the electronic system; continuing to input certificate recipient names via the entry form until all certificate recipient names have been input into the electronic system; arranging the recipient names in a desired order by the electronic system; and printing a certificate for each recipient from a printing system.

In another aspect, the invention may provide a method of producing a protective certificate package, the method comprising the steps of: providing an electronic certificate system to receive at least one certificate recipient's name via an entry form; inputting at least one certificate recipient name; continuing to input certificate recipient names via the entry form until all certificate recipient names have been input into the electronic system; arranging the recipient names in a desired order by the electronic system; printing a certificate for each recipient from a printing system; and providing a protective certificate cover to receive the certificate, the cover having two panels and a through aperture formed in one of the panels, said cover moveable between open and closed positions.

In yet another aspect, the invention may provide a protective certificate package comprising: a certificate cover including first and second panels that are moveable between an open and a closed position and adapted to receive a certificate atop the second panel; an aperture formed in the first panel; and a certificate having a print area on the certificate.

Another aspect of an embodiment of the present invention provides a protective certificate package comprising: a certificate cover including first and second panels moveable between an open and a closed position and adapted to receive a certificate atop the second panel; and an aperture formed in the first panel adapted to view a print area on the certificate when the cover is in the closed position.

### BRIEF DESCRIPTION OF THE SEVERAL VIEWS OF THE DRAWINGS

A sample embodiment of the invention, illustrative of the best mode in which Applicant contemplates applying the principles, is set forth in the following description, is shown in the drawings and is particularly and distinctly pointed out and set forth in the appended claims.

FIG. 1 is a top view of the present invention depicting an assembled protective certificate package;

FIG. 2 is a side view of the assembled protective certificate package;

FIG. 3 is a top exploded view of the present invention depicting the components of the protective certificate package in a disassembled position;

FIG. 4 is an enlarge top view depicting a certificate, shown in dashed lines, secured within a certificate cover in a closed position;

FIG. 5 is a perspective view of the certificate cover in an open position;

FIG. 6 is a perspective view of the certificate cover in an open position having a certificate secured to a second panel of the certificate cover;

FIG. 7 is a perspective view depicting the certificate secured within the certificate cover in the closed position;

FIG. 8 is top view depicting the closed certificate cover within an envelope having a window; and depicting a transparent sleeve positioned adjacent the envelope;

FIG. 9. is a bottom view depicting the closed certificate cover within the envelope; and depicting a transparent sleeve positioned adjacent the envelope; and

FIG. 10 is a flow chart of an exemplary method of producing a protective certificate package.

Similar numbers refer to similar parts throughout the drawings.

### DETAILED DESCRIPTION

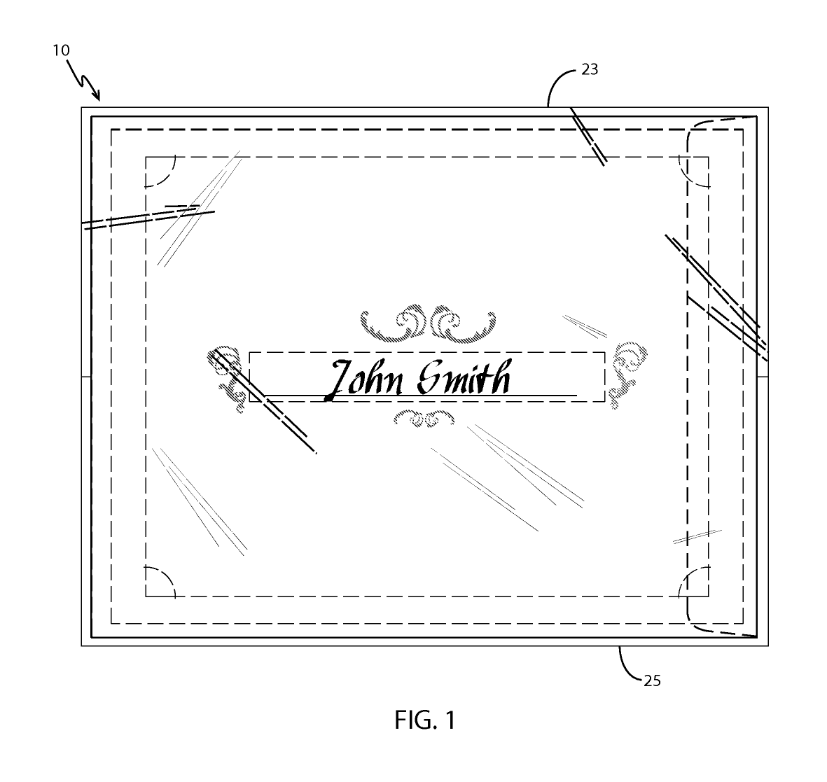

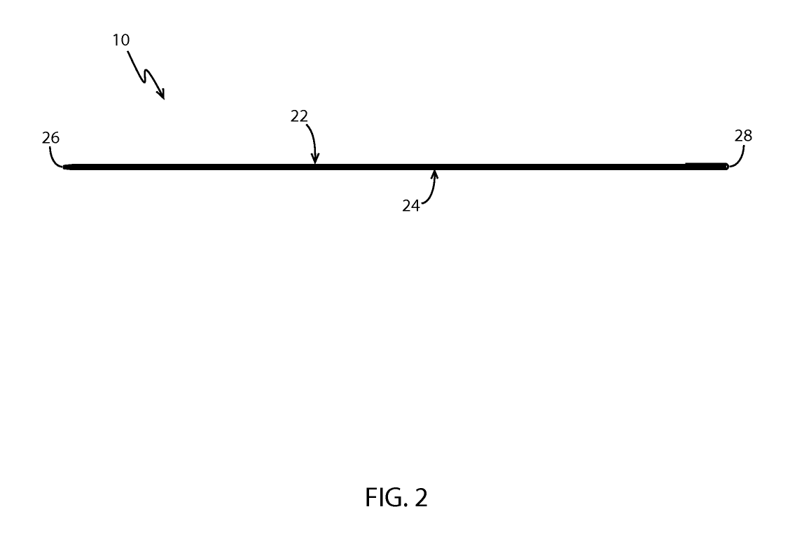

As shown generally in FIGS. 1-3, a certificate holder package 10 of the present invention is provided comprising a certificate 12, a certificate cover 15 having a first cover panel 14 and a second cover panel 16, an envelope 18, and a transparent sleeve 20. Package 10 is configured such that certificate 12 fits within cover 15 which may fit within in envelope 18 which may fit within sleeve 20 to define an assembled configuration. When assembled (FIG. 1), package 10 has an upwardly facing upper surface 22 (FIG. 2) and a downwardly facing bottom surface 24 (FIG. 2) that defines therebetween a vertical direction. Package 10 has a left side 26 and a right side 28 that define therebetween a longitudinal direction and package 10 has a first or front edge 23 and a second or rear edge 25 that define therebetween a transverse direction.

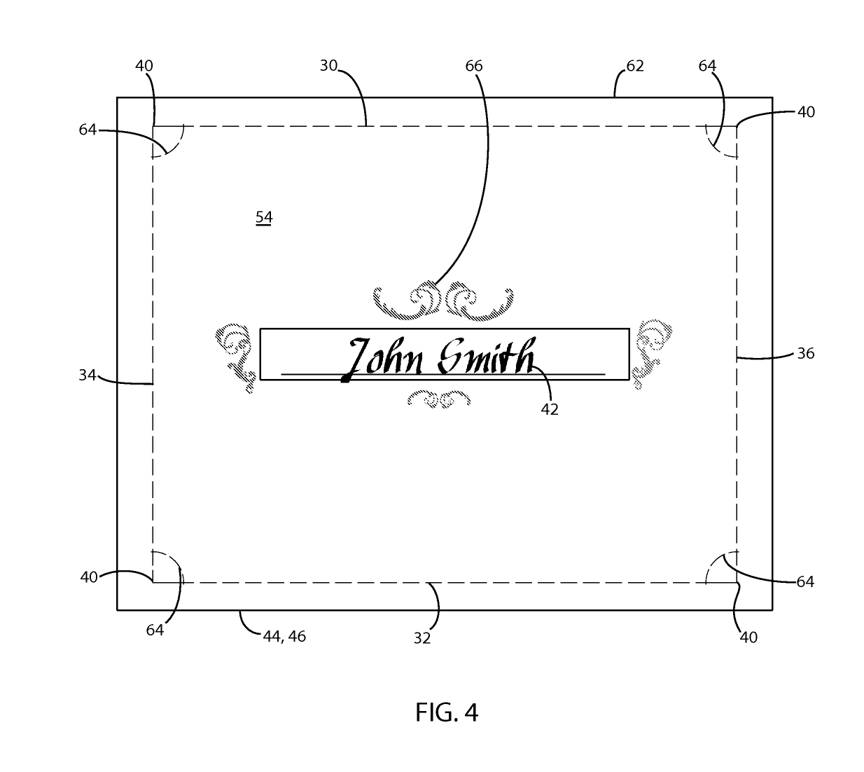

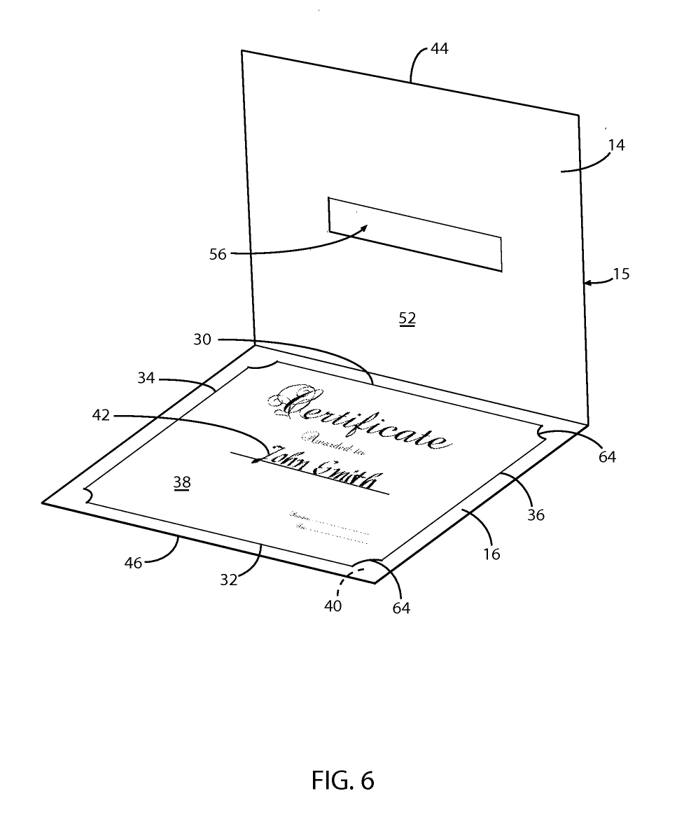

With primary reference to FIG. 4 and FIG. 6, certificate 12 includes a certificate first edge 30, a certificate second edge 32, a certificate left side 34, a certificate right side 36, a certificate upper surface 38 (FIG. 6), at least one corner 40, and a name printing area 42. First and second edges 30, 32 extend longitudinally and intersect perpendicularly the transversely extending certificate left and right sides 34, 36 forming right angles therein of the at least one certificate corners 40. Certificate upper surface 38 is bound by the connected edges 30, 32 and sides 34, 36 respectively. Certificate upper surface 38 faces vertically upward when viewed from above as seen in FIG. 6. Certificate lower surface (not shown) faces vertically downward when certificate 12 is positioned in its attached position (FIG. 6). Name printing area 42 is disposed on the upper surface 38 of certificate 12. Name printing area 42 is preferably centered both longitudinally and transversely. Name printing area 42 receives printed letters, from a printing system (not shown), forming the name of the certificate recipient.

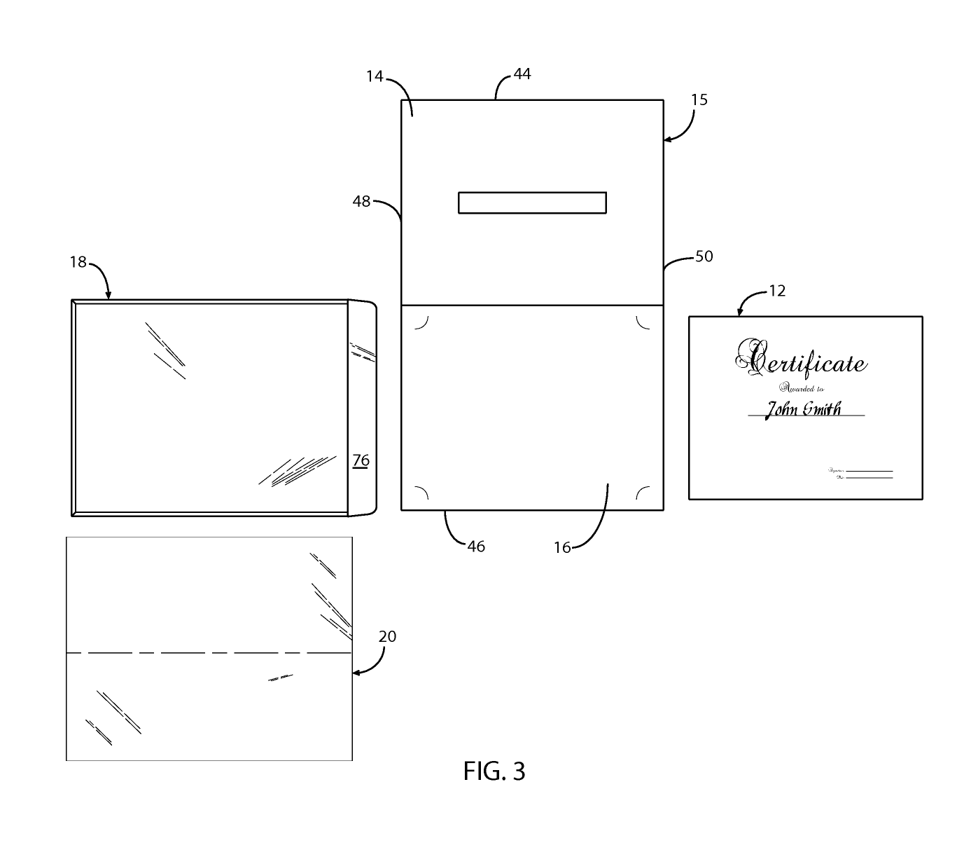

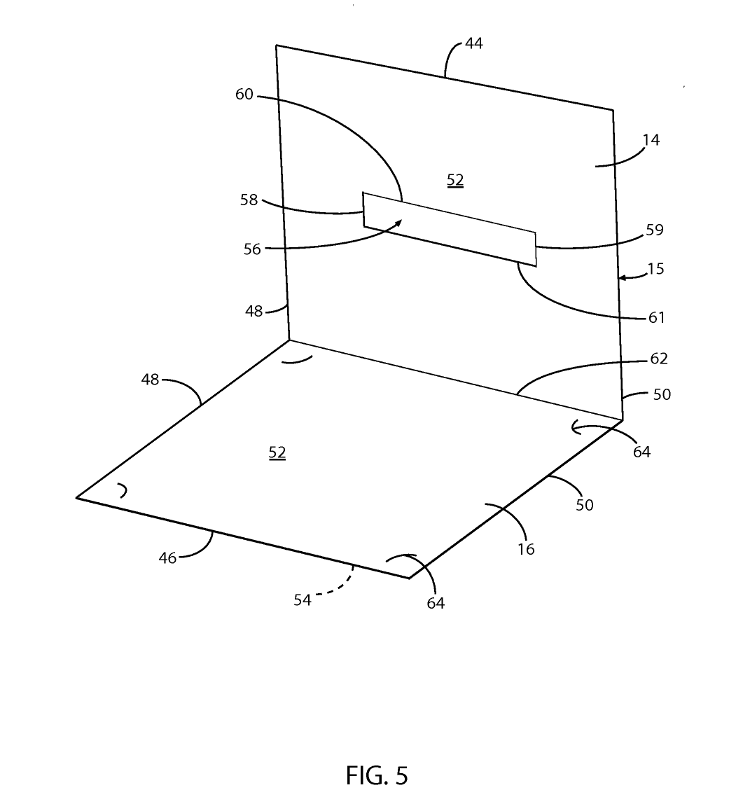

With continued reference to FIGS. 4-6, protective certificate cover 15 includes a cover top edge 44, a cover bottom edge 46, a cover left side 48, a cover right side 50, a cover inner surface 52, a cover outer surface 54, a cover aperture 56 formed in the first cover panel 14, retaining slits 64, and a living hinge 62. Cover top edge 44 extends longitudinally from cover left side 48 to cover right side 50. Cover bottom edge 46 extends longitudinally and generally parallel to cover top edge 44 from cover left side 48 to cover right side 50. Living hinge 62 extends substantially parallel to cover top edge 44 and cover bottom edge 46 from cover left side 48 to cover right side 50. Hinge 62 is preferably equidistant from top and bottom edges 44, 46. Living hinge 62 permits cover first panel 14 and second cover panel 16 to move relative one another between open and closed positions. When in the open position (FIG. 3), cover inner surface 52 faces upwardly and cover outer surface 54 (FIG. 4) faces downwardly. When cover 15 is moved towards the collapsed position (FIG. 6) about living hinge 62, first cover panel 14 is positioned closely adjacent and above second cover panel 16 so that edges 44, 46 are closely adjacent and preferably vertically aligned (FIG. 4). Further, cover 15 may contain filigree 66, preferably atop outer surface 54, which can take the form of aesthetically pleasing designs, logos, emblems, mascots, other words, borders, or other identifying marks or similar accoutrements traditionally associated with diplomas or certificates.

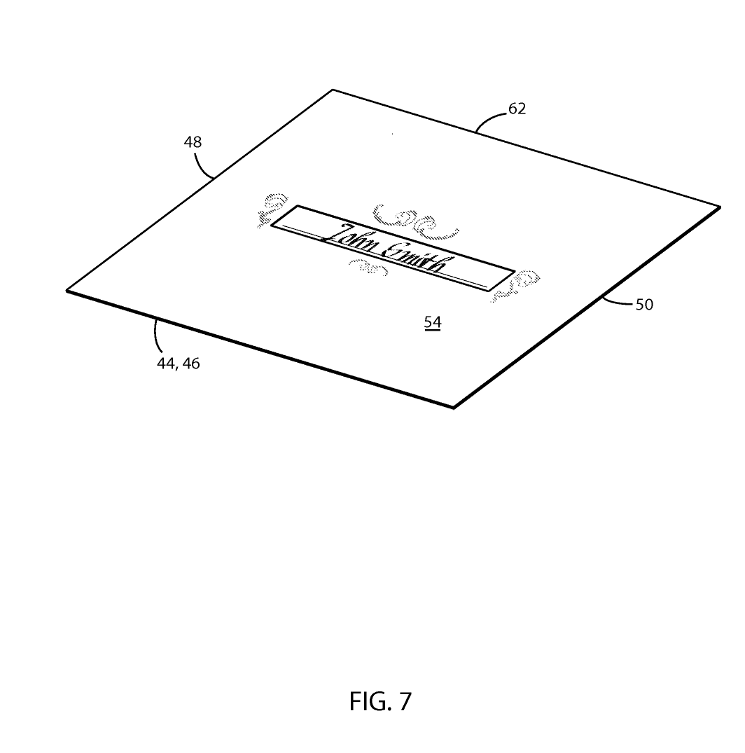

Cover aperture 56 is a through aperture formed in the first cover panel 14 extending from inner surface 52 to outer surface 54. Cover aperture 56 is bound by a first inner transverse edge 58 spaced apart and generally parallel to second inner transverse edge 59. Cover aperture 56 is also bound by a first inner longitudinal edge 60 spaced apart and generally parallel to second inner longitudinal edge edge 61. Cover aperture 56 aligns with name printing area 42 when certificate 12 has been positioned atop second cover panel segment 16 and the two panels 14, 16 are moved to the closed position about hinge 62 (FIG. 7). Certificate 12 may be secured to second panel 16 via the retaining slits or retaining members 64. Slits 64 extend from inner surface 52 partially through the second panel 16. Slits 64 are located adjacent the corners of inner surface 52 bound by cover bottom edge 46, cover left side 48, cover right side 50, and an edge of hinge 62.

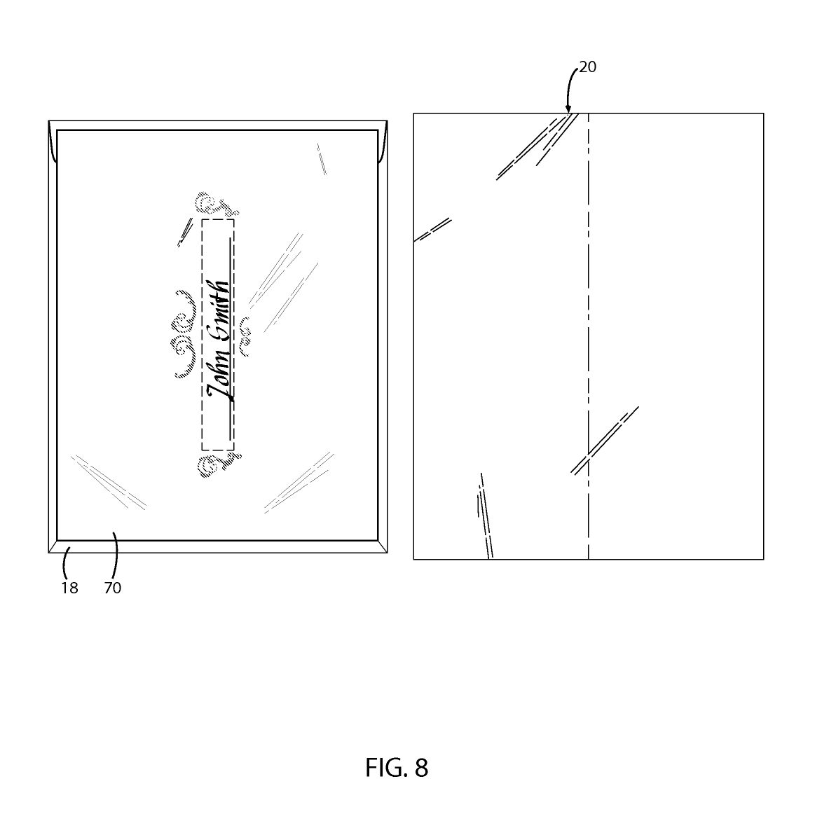

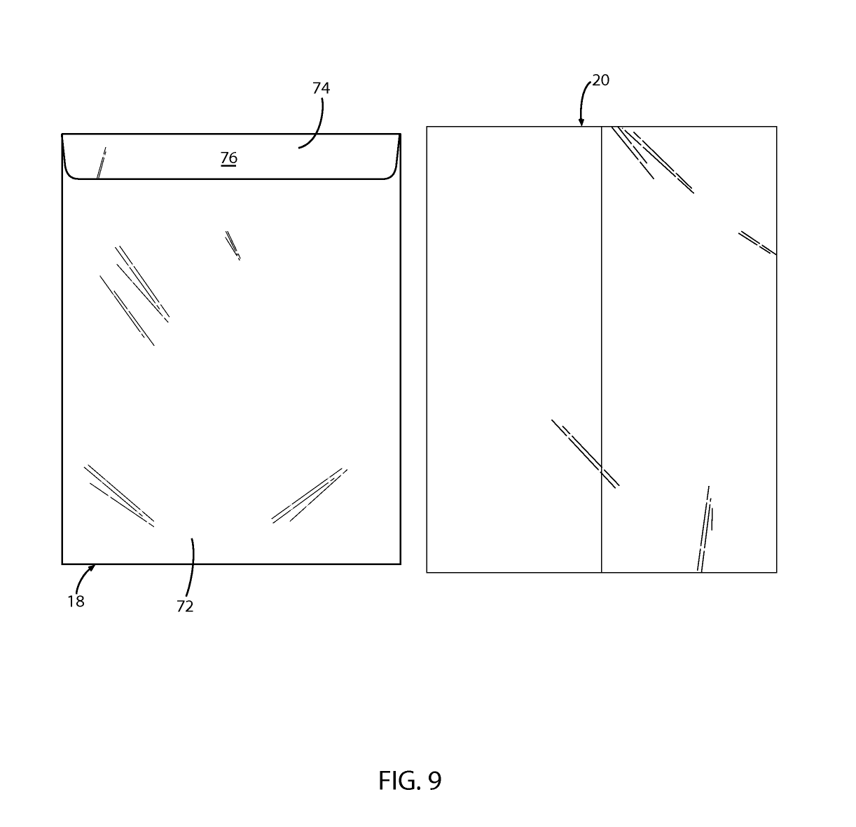

With primary reference to FIGS. 8-9, envelope 18 includes a viewing window 70 formed in and at least partially defining the front side, a back side 72, and a sealing flap 74. Envelope 18 is configured to receive protective certificate cover 15 in its closed position such that the name printing area 42 is visible through both the cover aperture 56 and viewing window 70. Sealing flap 74 has a first surface 76 which is part of the front side respectively when envelope 18 is laid flat and in an open and receiving position (FIG. 3). Sealing flap 74 may be folded over along edge adjacent right side 28. Once folded over, first surface 76 of sealing flap 74 is facing opposite front side and generally coplanar with back side 72. Sealing flap 74 may be sealed to the front side through conventional means such as adhesive or other clasps to secure closed cover 15 in envelope 18. Sealed envelope 18 may then be received by transparent sleeve 20. Transparent sleeve 20 is preferably a cellophane type plastic and able to be sealed by being heated or shrink wrapped to further secure and seal envelope 18 containing closed cover 15 having certificate 12 positioned inside with print area 42 viewable through aperture 56 and window 70. Alternatively, cover 15 containing certificate 12 may be placed directly within transparent sleeve 20 without the need for envelope 18.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

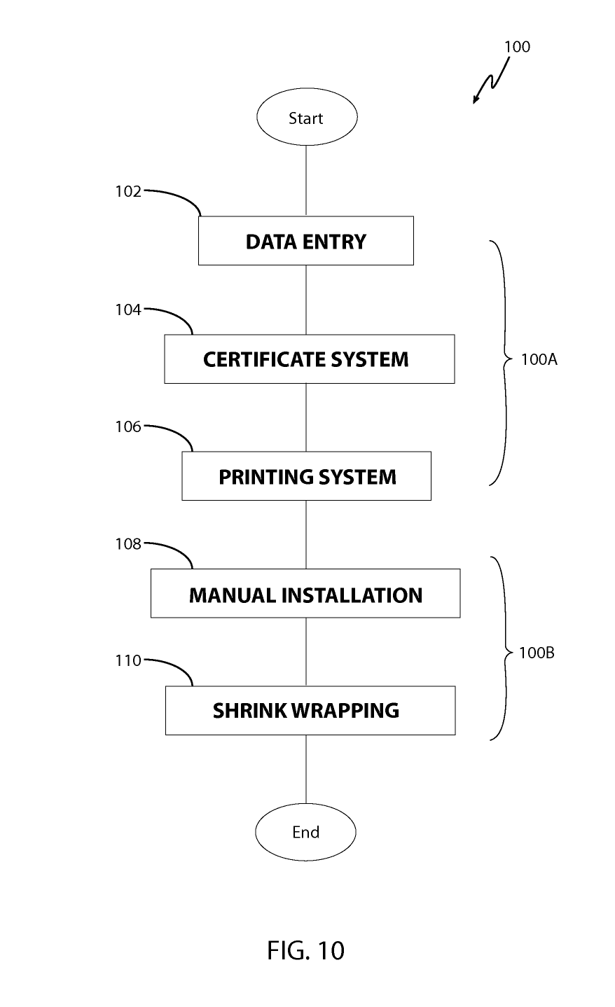

FIG. 10 illustrates an exemplary method 100 for producing a certificate in a protective cover having an electronic segment 100A and a manual segment 100B. The electronic segment 100A requires inputting names of certificate recipients or other data entry 102 into the electronic certificate system. The certificate system then organizes the data 104 into a desired arrangement. Preferably, the certificate system organizes the entered data using logic in alphabetical order, however other configurations are clearly possible. The certificates are then printed via a certificate printing system running printing logic 106. Once the certificates have been printed the electronic segment 100A ends.

The manual segment 100B of method 100 begins shortly after electronic segment 100A ends. Manual segment 100B includes the manual installation or assembly of printed certificates 108 into certificate cover by securing certificate to cover and closing the cover 15 ensuring that print area 42 is viewable through cover aperture 56, then placing a closed cover into envelope 18. Then certificates contained within the cover in the envelope may then be shrink wrapped 110 for further protection.

In operation, a user will enter or input informational or identification data into a computer system having program logic configured to identify the informational data. Preferably, the informational or identification data will be a certificate recipient's name, but other data can be substituted instead of the recipient name. Further, the computer system can be isolated within one computer or connected to multiple computers via a computer network. The component system may run on an internet network capable of being remotely accessed from several computers via the computer network or from an internet hosted website. Further, the user uploading the information can be a single person or multiple people. In the preferred embodiment, the informational data is input into a data form.

A certificate system program configured to be executed by the computer system will extract information from the data form. The information extracted permits the data input to be arranged in a manner desirable for an operator. The operator may be the same person as the user, but it is not necessary. Extracted information is preferably the recipient's name. When multiple names are input via the data entry form, the certificate system may put the names in alphabetical order. Certificate system then sends names to a printing system.

Printing system prints one name or one piece of information per certificate. The printing system then prints the remaining names left to be printed from the data entry until all certificates, each containing one name, has been printed. The printing system is a high quality diploma or certificate printing system as ordinarily understood in the art.

The uploading of informational data or extraction of embedded information from the data input form can be controlled by a processor or other logic. “Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

A person will then manually assemble (the Assembler) the protective certificate package of the present invention. Assembler will take one protective cover 15 and move it to an open position laid flat (FIG. 3) with the inner surface facing upwards. Assembler will grasp a printed certificate and position the certificate atop the upper surface of the second panel 16. Assembler will ensure that print area 42 is upwardly facing. User will then tuck corners 40 into retaining member 64 to secure certificate 15 to cover 15. Assembler will then move first panel 14 about living hinge 62 to move cover 15 towards (FIG. 6) the closed position (FIG. 4). Assembler should ensure the name in the printed area 42 is visible through and aligned with cover aperture 56.

Assembler will then insert the closed cover 15 into envelope 18 such that printed area 42 containing the recipient's name is visible through window 70 along front side. Sealing flap 72 is then sealed to secure cover 15 within envelope 18. Sealed envelope 18 may then be further placed within the transparent sleeve 20 and heat shrunk forming a preferably hermetic sealed certificate package 10. Printed area 42 is viewable when sealed envelope 18 is sealed within transparent sleeve 20. Alternatively, closed cover 15 may be sealed within sleeve 20 without an envelope 18.

The term “certificate” as used throughout the specification, claims, and figures refers to any physical memorialization of achievement, completion, or qualification, including but in no way limited to academic diplomas, acknowledgements of merit, deeds, degrees, testamoniums, photographs, or parchments and the like.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the invention are an example and the invention is not limited to the exact details shown or described.

1. A protective certificate package comprising:
a certificate cover including first and second panels moveable between an open and a closed position and adapted to receive a certificate atop the second panel;
an aperture formed in the first panel adapted to view a print area on the certificate when the cover is in the closed position; and
a certificate comprising a first print area with text of a recipient name, wherein the name is viewable through the aperture when the certificate is positioned atop the second panel and the cover is in the closed position.

2. The protective certificate package of claim 1, further comprising:
a second print area on the certificate comprising printed word text, wherein the second print area is covered by the first panel when the certificate is positioned atop the second panel and the cover is in the closed position.

3. The protective certificate package of claim 2, further comprising:
an envelope having two planar surfaces, wherein at least one surface comprises a transparent window;
wherein the envelope is configured to receive the certificate cover in the closed position; and
wherein the recipient name text in the first print area is viewable through the window and through the aperture when the certificate is positioned atop the second panel in the closed position and the closed certificate cover is inside the envelope.

4. The protective certificate package of claim 3, further comprising:
a hermetically sealed transparent sleeve receiving the envelope therein; and
wherein the recipient name text in the first print area is viewable through the transparent sleeve, the window, and the aperture when the certificate is positioned atop the second panel in the closed position and the closed certificate cover is inside the envelope and the envelope is inside the transparent sleeve.

5. (canceled)

6. The protective certificate package of claim 1, wherein the cover further comprises four retaining members.

7. The protective certificate package of claim 6, wherein the retaining members are slits extending at least partially through the second panel.

8. The protective certificate package of claim 6, wherein the retaining members are slits are positioned adjacent four corners of an inner surface, said inner surface bound by a cover bottom edge, a cover left side, a cover right side, and a hinge edge.

9. The protective certificate package of claim 1, wherein the cover further comprises a hinge connecting first and second panels.

10. (canceled)

11. The protective certificate package of claim 3, wherein the envelope includes a sealing flap located adjacent a side of the envelope.

12. The protective certificate package of claim 1, further comprising a hermetically sealed transparent sleeve receiving the certificate cover in the closed position.

13. The protective certificate package of claim 1 free of any adhesive label affixed to the certificate cover.

14. A method of producing a protective certificate package, the method comprising the steps of:
providing an electronic certificate system on a computer programmed to receive at least one certificate recipient's name via an entry form;
inputting at least one certificate recipient name via the entry form into the electronic system;
continuing to input certificate recipient names via the entry form until all certificate recipient names have been input into the electronic system;
arranging the recipient names in a desired order by the electronic system;
printing text of a single recipient name in a first print area on a single certificate;
providing a protective certificate cover to receive the certificate, the cover having first and second panels and a through aperture formed in the first panel, said cover moveable between open and closed positions and;
positioning the certificate atop one of the panels, wherein the recipient name is viewable through the aperture when the certificate is atop the second panel and the cover is in the closed position.

15. The method of claim 14, further comprising the steps of:
removing the printed certificates from the printing system;
opening a protective cover;
releasably securing one printed certificate to one protective cover;
closing the protective cover; and
ensuring the print area is viewable through the aperture.

16. The method of claim 15, wherein the step of releasably securing one printed certificate to one protective cover, further comprises the step of sliding each corner of the printed certificate into a slit formed in the protective cover.

17. The method of claim 15, further comprising the steps of:
sliding the closed protective cover into an envelope having a viewing window extending along one side of the envelope;
ensuring the print area is viewable through the viewing window and the aperture; and
sealing the envelope.

18. The method of claim 17, wherein after sealing the envelope comprises the steps of:
sliding the sealed envelope into a hermetically sealable transparent sleeve;
ensuring the print area is viewable through the transparent sleeve, the viewing window, and the aperture; and
hermetically sealing the transparent sleeve.

19. The method of claim 15, further comprising the steps:
sliding the closed protective cover into a hermetically sealable transparent sleeve;
ensuring the print area is viewable through the transparent sleeve and the aperture; and
hermetically sealing the transparent sleeve.

20. The protective certificate package of claim 1, wherein the first print area consists of only a single recipient name text.

21. The method of claim 14, further comprising the steps of:
printing word text in a second print area on the single certificate, wherein the second print area is covered by the panel forming the aperture when the certificate is releasably secured within the cover in the closed position.

22. A method of use for a protective certificate package, the method comprising the steps of:
printing a certificate including a first print area and a second print area, the first print area comprising text of a single recipient name;
providing a protective certificate cover including a first panel, a second panel, and a name viewing aperture formed in the first panel, said cover moveable between open and closed positions; and
positioning the certificate atop the second panel, wherein the recipient name is viewable through the aperture when the cover is in the closed position.
